(19) United States
(12) Patent Application Publication
(10) Pub. No.: US 2026/0120907 A1
(43) Pub. Date: Apr. 30, 2026

(54) DEEP GEOLOGICAL DISPOSAL FACILITY FOR SPENT NUCLEAR FUEL AND A SIMULATING APPARATUS FOR DEEP GEOLOGICAL DISPOSAL FACILITIES OF SPENT NUCLEAR FUEL

(71) Applicant: KOREA RADIOACTIVE WASTE AGENCY, Gyeongju-si, Gyeongsangbuk-do (KR)

(72) Inventors: Ji Seon JANG, Yuseong-gu, Daejeon (KR); Jeong Hwan LEE, Yuseong-gu, Daejeon (KR); Mi Seon JEONG, Yuseong-gu, Daejeon (KR); Chang Min SHIN, Yuseong-gu, Daejeon (KR); Hyung Joo YUN, Yuseong-gu, Daejeon (KR); Seo Yeon CHO, Yuseong-gu, Daejeon (KR)

(21) Appl. No.: 19/060,473

(22) Filed: Feb. 21, 2025

(30) Foreign Application Priority Data
Aug. 21, 2024 (KR) 10-2024-0112193

(51) Int. Cl. G21F 9/36; G21F 1/12

(52) U.S. Cl. CPC G21F 9/36; G21F 1/125

(57) ABSTRACT

Provided is a deep geological disposal facility for spent nuclear fuel and a simulating apparatus for deep geological disposal facilities of spent nuclear fuel, wherein the engineered barrier consists of a canister, a buffer, a backfill and a supercontainer, while the canister comprises a first membrane layer for withstanding corrosion and pressure with spent nuclear fuel; the buffer is made of a material which make nuclide migration delay in case that nuclide is leaked out of the canister; the backfill is made of a material which limits nuclide migration, as engineered barrier; and the supercontainer consists of a second membrane layer for withstanding corrosion and having a low heat conductivity, and wherein the natural barrier is filled with host rock at a depth of more than 500 meters for delaying nuclide transport when nuclide leaks out and preventing radioactive materials from being leaked out toward environment.

### TECHNICAL FIELD

The present invention relates to a deep geological disposal facility for spent nuclear fuel and, more specifically, to a deep geological disposal facility for spent nuclear fuel and a simulating apparatus for deep geological disposal facilities of spent nuclear fuel wherein high stability and superior consistency are preserved for a long period while ground remains unaffected despite of transport of radioactive material, contained in spent nuclear fuel at deep geological disposal facilities, and nuclear leakage.

### BACKGROUND ART

Deep underground geological disposal has been considered for permanently isolating people's lives from spent nuclear fuel and high-level radioactive waste, produced from nuclear power generation. In such deep underground geological disposal, metal canisters, primarily containing radioactive waste, are arranged to penetrate multiple disposal tunnels at hundreds of meters of kilometers underground. At this time, the canisters are wrapped with buffer and backfill for protecting canisters from unexpected external shocks and retarding the transport of radioactive nuclide in spite of leakage of radioactive nuclide due to corrosion of canisters for a long period of time. Canister, buffer, backfill, etc., artificially installed for blocking the transport of radioactive material, are called as engineered barrier, and underground host rock is called as natural barrier.

With a long-term point of view, high temperature and underground water, which may be generated from disposal environment, may deteriorate performance of constitutional elements of barriers. It is extremely important to evaluate long-term safety of disposal system, and alteration and degradation of constitutional elements of barriers, and anticipate nuclide transport due to nuclide leakage from metal containers Thus, a simulating testing method or apparatus is required.

However, for experimental simulation of disposal environment of radioactive waste, heat source with uniform heat transfer and a method of heat transfer are required, and durability must be ensured in a long-term aspect as well. Further, it has been required to conduct a research for simulation of how nuclide and solute are transferred not by injection of reacting solution and solute due to artificial pressure, but by proliferation, based on concentration gradient, and inflow of underground water anticipated in real disposal environment.

Meanwhile, according to safety standards (SSG-14) [3] of International Atomic Energy Agency (IAEA), it has been recommended to apply for multiple barriers when designing deep geological disposal facilities. Currently, every countries which perform deep geological disposal facilities have conformed to safety standards of IAEA and conducted a design based on a concept of multiple safety function by multiple barriers. Also, according to notification (no. 2021-24) [4], Article 11(2) in Nuclear Safety and Security Commission, it is stated to constitute disposal facilities by reflecting IAEA recommendation and considering multiple safety functions by multiple barriers [4]. Isolation and containment of radioactive waste in deep geological disposal facilities are implemented by multiple safety functions which are provided by multiple barriers consisting of artificial barriers and natural barriers. Also, multiple safety functions are embodied not only through physical and chemical characteristics of multiple barriers, but also through design and operation of deep geological disposal facilities.

Prior arts in relation to the simulating apparatus of spent nuclear fuel or radioactive waste are as follows.

First, the Korean Patent Registration no. 10-0989330 (hereinafter, ‘Patent Document 1’) discloses an apparatus for simulating and visualizing the behavior of groundwater/nuclides for estimating the radioactive waste disposal system for comprising a model of fractured rock; an ultraviolet lamp; a photographic device; a housing; and a microprocessor for simulating and visualizing behavior of underground water and nuclides generated in radioactive waste disposal sites.

Further, the Korean Patent Registration no. 10-2279532 (hereinafter, ‘Patent Document 2’) discloses an apparatus for seismic structural integrity evaluation of spent fuel, spent fuel storage racks and storage tank comprising a simulating storage tank; first simulating storage racks; second simulating storage racks; and simulating nuclear fuel for evaluating seismic structural integrity of spent fuel storage racks and storage tank.

Further, the Korean Patent Registration no. 10-2631902 (hereinafter, ‘Patent Document 3’) discloses a deep disposal of radioactive waste simulating apparatus comprising a deep disposal environment simulating part; a detecting part; and a controlling part for simulating transport of nuclides and solute due to proliferation, based on concentration gradient, and inflow of underground water anticipated in deep disposal environment.

Further, the Korean Patent Registration no. 10-2640319 (hereinafter, ‘Patent Document 4’) discloses a deep disposal of radioactive waste gas behavior simulating apparatus comprising a first reacting part; a second reacting part; a detecting part; and controlling part for testing behavior of gas and nuclide containing fine particles in deep disposal environment of high temperature and pressure, whereas the controlling part analyzes the behavior of nuclide containing fine particles by gas through analyzing an average size of bubble particles and analyzing correlation of an average size of the bubble particles and particle amount transported by the bubble.

However, as for the Patent Document 1, it may be possible to anticipate moving behavior of underground water and nuclide nearby radioactive waste disposal sites and improve reliability of safety evaluation. However, the Patent Document 1 not only has complicated technical constitution, but partially leaked nuclide has a bad influence to the ground.

The Patent Document 2 conducts a test by reduction of real storage facility and spent nuclear fuel. However, it is hard to check whether or not to leak out nuclide of spent nuclear fuel in real deep disposal facilities and to check for attaining stability.

Further, the Patent Document 3 consistently delivers heat by metal containers and simulates behavior of nuclide and solute. However, it is hard to find out whether or not to have a bad influence to the ground by nuclide leakage and to obtain long-term safety.

As for the Patent Document 4, it is difficult to control the behavior of radioactive material and contact of underground water as much as possible and to obtain long-term safety.

### PRIOR ART

(Patent document 001) Korean Patent Registration No. 10-0989330
(Patent document 002) Korean Patent Registration No. 10-2279532
(Patent document 003) Korean Patent Registration No. 10-2631902
(Patent document 004) Korean Patent Registration No. 10-2640319

### DISCLOSURE

### Technical Problem

For solving above problems, the object of the present invention is to provide a deep geological disposal facility for spent nuclear fuel and a simulating apparatus for deep geological disposal facilities of spent nuclear fuel wherein high stability and superior consistency are preserved for a long period while ground remains unaffected despite of transport of radioactive material, contained in spent nuclear fuel at deep geological disposal facilities, and nuclear leakage.

Further, the another object of the present invention is to provide a simulating apparatus for constructing design specification of deep geological disposal facilities comprising optimal conditions.

Further, the another object of the present invention is to provide technical grounds for gaps of canisters which are to be reflected to basic designs of deep geological disposal facilities.

### Technical Solution

To accomplish above objects, a deep geological disposal facility for spent nuclear fuel comprises a multiple barrier system having an engineered barrier and a natural barrier, wherein the engineered barrier consists of a canister, a buffer, a backfill and a supercontainer, while the canister comprises a first membrane layer for withstanding corrosion and pressure with spent nuclear fuel; the buffer is made of a material which make nuclide migration delay in case that nuclide is leaked out of the canister; the backfill is made of a material which limits nuclide migration, as engineered barrier; and the supercontainer consists of a second membrane layer for withstanding corrosion and having a low heat conductivity, and wherein the natural barrier is filled with host rock at a depth of more than 500 meters for delaying nuclide transport when nuclide leaks out and preventing radioactive materials from being leaked out toward environment.

Hereinafter, the first membrane layer comprises copper and iron materials.

Hereinafter, the buffer is made of compressed bentonite, and the backfill is made of granular bentonite.

Hereinafter, the second membrane layer is made of titanium.

Hereinafter, the host rock is made of granite.

A simulating apparatus for deep geological disposal facilities of spent nuclear fuel comprises: an environment simulating part of a geological disposal facility for simulating the geological disposal facility for disposal of spent nuclear fuel; and a chamber, with which the geological disposal facility is equipped, for performing isothermal-isohumidity control in the environment simulating part of the geological disposal facility, wherein the chamber comprises a column in which a plurality of simulating members is consecutively stacked from the bottom; a supply pump for supplying test liquid, mixing underground water and radioactive nuclide liquid inside a storage tank, to the bottom of the column for implementing spent nuclear fuel; and a storage pump for storing the test liquid, which goes through a plurality of simulating members inside the column, to a storage tank on the top of the column.

Hereinafter, the plurality of simulating members is composed of a canister simulating member including copper and iron membranes from the bottom; a buffer simulating member which is compressed bentonite; a backfill simulating member which is granular bentonite; a supercontainer simulating member including titanium-coated membranes; and a host rock simulating member filled with granite.

Hereinafter, the simulating apparatus is connected to at least one or more than plurals.

### Advantageous Effects

The present invention enables to maximize reliability of a simulating apparatus for deep geological disposal facilities of spent nuclear fuel as well as obtain high safety by preserving high stability and superior consistency for a long period while ground remains unaffected despite of transport of radioactive material, contained in spent nuclear fuel at deep geological disposal facilities, and nuclear leakage.

Further, it enables to establish deep geological disposal facilities with optimal conditions in accordance with geological characteristics by providing a simulating apparatus for constructing design specification of deep geological disposal facilities comprising optimal conditions.

Further, it enables to build up deep geological disposal facilities with optimal conditions by providing technical grounds for gaps of canisters which are to be reflected to basic designs of deep geological disposal facilities.

### DESCRIPTION OF DRAWINGS

FIG. 1 illustrates a concept mapping explaining underground laying for explanation of a deep geological disposal facility for spent nuclear fuel according to the present invention.

FIG. 2 illustrates a cross section according to the FIG. 1.

FIG. 3 illustrates a concept mapping explaining a simulating apparatus for deep geological disposal facilities of spent nuclear fuel according to the present invention.

FIG. 4 illustrates a reference drawing for explaining other embodiment according to FIG. 3.

### DESCRIPTION OF THE PREFERRED EMBODIMENTS

The desirable embodiments of the present invention will be described in detail with the accompanying drawings as follows, and the present invention is not defined by embodiments.

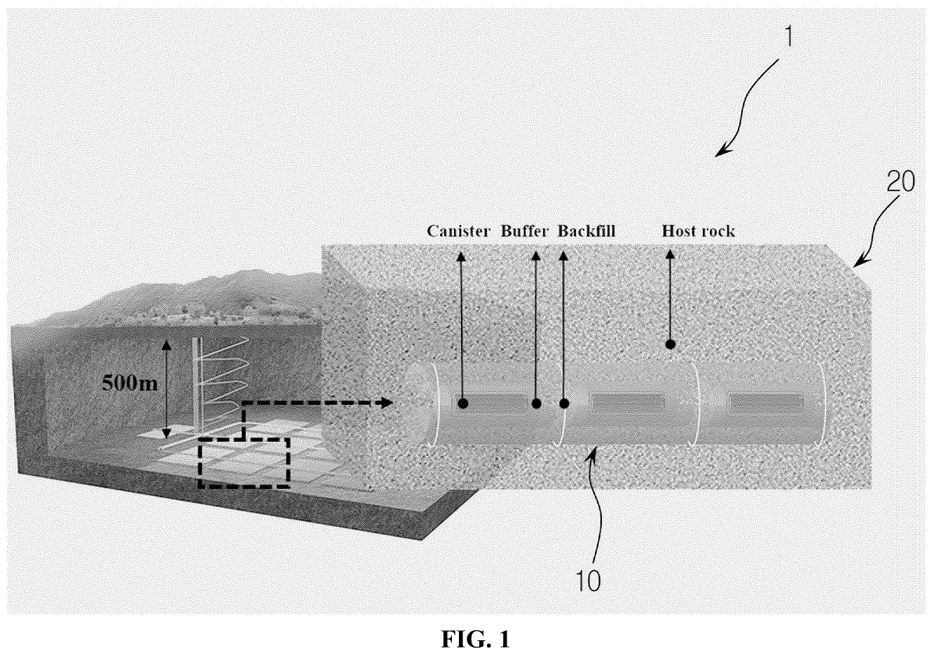

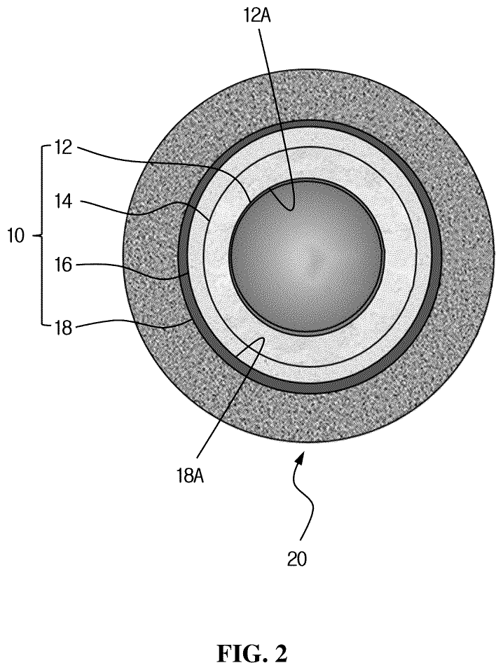

FIG. 1 illustrates a concept mapping explaining underground laying for explanation of a deep geological disposal facility for spent nuclear fuel according to the present invention; and FIG. 2 illustrates a cross section according to the FIG. 1.

As illustrated, multiple safety functions of multiple barriers constituting a deep geological disposal facility for spent nuclear fuel include isolation, containment, nuclear release and migration retardation, consistency of constitutional elements of disposal facility, and long-term safety, and these multiple safety functions are illustrated in Table 1 below. The safety functions described in Table 1 are configured based on a deep geological disposal facility which is in the step of concept design. Accordingly, in case that site for a deep geological disposal facility will be established in the future, relevant continued supplement is required.

TABLE 1
Multiple safety functions of a deep geological
disposal facility for spent nuclear fuel

| Multiple safety functions | Content |
|---|---|
| Isolation | Generally, isolation is provided by the depth of |
| | bedrock in which a deep geological disposal |
| | facility is established. However, closure, plug, |
| | etc., of a deep geological disposal facility |
| | influence isolation. |
| Containment | Containment of a deep geological disposal facility |
| | is mainly provided by a disposal canister. Besides, |
| | partially safe bedrock influences containment. |
| | Containment should be maintained until heat from |
| | high-level radioactive waste is low enough. |
| Nuclear release and | After releasing containment of disposal system, |
| migration retardation | nuclear release and migration retardation |
| | significantly influence disposal safety. The |
| | nuclear release and migration retardation are |
| | affected the most by characteristics of radioactive |
| | waste for disposal, buffer and backfill, and |
| | characteristics of natural barrier. |
| Consistency of constitutional | Individual element constituting a disposal system |
| elements of disposal | should be selected and designed for not providing |
| facility | damaging effects. |
| Long-term safety | The deep geological disposal facility should be |
| | established on safe bedrock for minimizing the |
| | influence of geologic event and |
| | phenomena(earthquake, uplift, etc.) in the future. |
| | The long-term safety is provided by natural |
| | barrier, and this should be considered enough |
| | when selecting site of the deep geological |
| | disposal facility. |

The present invention provides a simulating apparatus for deep geological disposal facilities of spent nuclear fuel wherein high stability and superior consistency are preserved for a long period while ground remains unaffected despite of transport of radioactive material, contained in spent nuclear fuel at deep geological disposal facilities, and nuclear leakage.

A deep geological disposal facility (l) for spent nuclear fuel according to the present invention consists of a multiple barrier system which includes an engineered barrier (10) and a natural barrier (20).

The engineered barrier (10) consists of a canister (12), a buffer (14), a backfill (16) and a supercontainer (18).

The canister (12) comprises a first membrane layer (12A) for withstanding corrosion and pressure with spent nuclear fuel.

It is desirable that the first membrane layer (12A) comprises copper and iron materials. That is, it is desirable that the first membrane layer (12A) is composed of two layers, which are one copper layer and one iron layer.

In other words, the canister including high-level radioactive waste for disposal must endure mechanical load and withstand corrosion in disposal environment. Further, the canister must maintain containment function until heat from high-level radioactive waste is low enough to go down.

That is, the canister must endure load, hydrostatic pressure, bedrock shear deformation and buffer swelling pressure for containment function; maintain slow corrosion speed; maintain subcritical state; and perform shielding function for preventing leakage of underground water outside the canister.

Further, the canister must have strong nuclide adsorption (adsorption capacity) and inflow limitation toward underground water (hydraulic conductivity) for nuclear release and migration retardation.

Further, the canister must limit external temperature of the canister for consistency of constitutional elements of a disposal system.

Accordingly, the canister of the present invention comprises the first membrane layer, thereby enabling to set up consistency of constitutional elements of a disposal system as well as containment, nuclear release and migration retardation.

The buffer (14) is made of a material which make nuclide migration delay in case that nuclide is leaked out of the canister (12).

It is desirable that compressed bentonite is used in the buffer (14).

In other words, the buffer must protect the canister against load, hydrostatic pressure, bedrock shear deformation, etc.; perform natural swelling (swelling pressure, in-place density); and support a surface of disposal tunnel from potential bedrock damages as well as limiting strong nuclide adsorption (adsorption capacity) and behavior characteristics of corrosion materials and colloid for nuclear release and migration retardation and limiting inflow of underground water toward the disposal tunnel (hydraulic conductivity, in-place density, swelling pressure).

Accordingly, it is desirable that compressed bentonite is used in the buffer.

The backfill (16) is made of a material which limits nuclide migration, as engineered barrier.

It is desirable that the backfill (16) is made of granular bentonite.

In other words, the backfill acts as isolation function (integrity) from underground water penetration; prevents underground water's advection from nuclide leakage and migration retardation; isolates a disposal tunnel in a hydraulic manner (hydraulic conductivity); and protects the buffer and the canister for consistency of constitutional elements of the disposal system and prevents the buffer from being deformed.

Accordingly, it is desirable that the backfill is made of granular bentonite.

It is desirable that the supercontainer (18) consists of a second membrane layer (18A) for withstanding corrosion and having a low heat conductivity.

It is desirable that the second membrane layer is made of titanium.

In other words, it may be possible for titanium to withstand corrosion; have a low heat conductivity; and easily generate curves with small elastic modulus. Thus, the supercontainer may be easily manufactured, light and strong.

Accordingly, it is desirable that the supercontainer forms the second membrane layer of titanium.

It is desirable that the natural barrier (20) is filled with host rock at a depth of more than 500 meters for delaying nuclide transport when nuclide leaks out and preventing radioactive materials from being leaked out toward environment.

It is desirable that the host rock is made of granite as a highly possible media for high-level radioactive waste disposal in the nation.

In other words, the natural barrier indicates disposal tunnels, disposal caves and bedrock surrounding other underground caves, and when the nuclide leaks out, the natural barrier delays nuclide transport.

That is, it is desirable that the disposal depth of the natural barrier is more than 500 meters under the ground, for isolation; the natural barrier should have slow water speed of underground water, thereby causing delay of nuclide leakage and migration, the minimized underground water (hydraulic conductivity), flowed into the disposal tunnel, and a path of nuclide migration long enough; and the natural barrier should be restored after shutdown. Further, the natural barrier should include underground condition (ionic strength, etc.) which minimizes erosion of the buffer and the backfill with consistency of constitutional elements of geological disposal system; underground condition (pH, etc.) for preventing corrosion of the canister; safe deep bedrock which may minimize impact on the engineered barrier from geological events and phenomenon for long-term safety, and characteristics of low erosion and uplift (erosion rate, uplift rate). Also, the natural barrier should be influenced by climate change at the least.

Thus, it is desirable that the natural barrier is filled with granite as host rock.

Accordingly, the present invention meets requirements of consistency of constitutional elements of disposal system and long-term safety as well as isolation, containment, nuclear release and migration retardation as safety functions of the deep geological disposal system in Table 1, thereby enabling to establish high stability and superior consistency for a long period while not causing influence to the ground in spite of nuclide leakage, as well as controlling migration of radioactive materials and contact of underground water at the most.

Thus, it may be possible to obtain highly safe conditions in any areas and improve reliability of a simulating apparatus of deep geological disposal facilities.

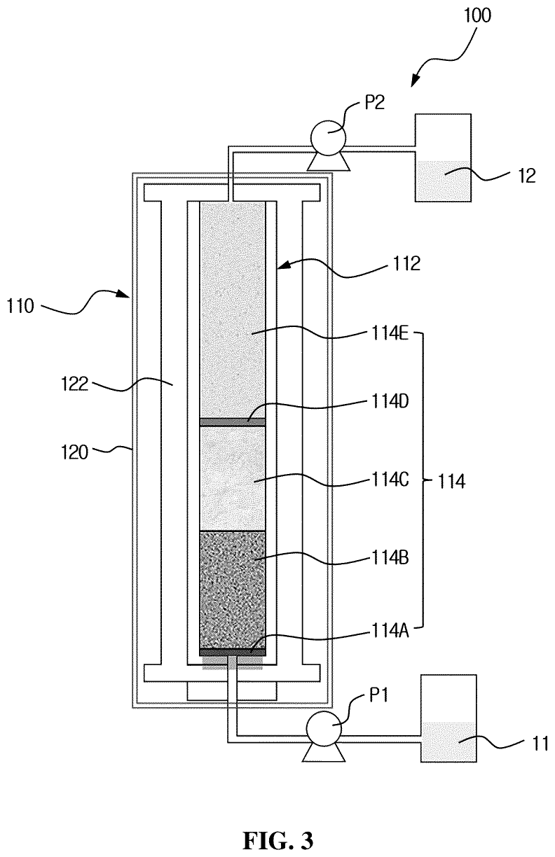

FIG. 3 illustrates a concept mapping explaining a simulating apparatus for deep geological disposal facilities of spent nuclear fuel according to the present invention.

As illustrated, the simulating apparatus for deep geological disposal facilities of spent nuclear fuel comprises detailed technical constitutions as follows.

The simulating apparatus (100) according to the present invention consists of an environment simulating part (110) of a geological disposal facility for simulating the geological disposal facility (112) for disposal of spent nuclear fuel; and a chamber (120), with which the geological disposal facility (112) is equipped, for performing isothermal-isohumidity control in the environment simulating part (110) of the geological disposal facility, wherein the chamber (120) comprises a column (122) in which a plurality of simulating members (114) is consecutively stacked from the bottom; a supply pump (P1) for supplying test liquid, mixing underground water and radioactive nuclide liquid inside a storage tank (T1), to the bottom of the column (122) for implementing spent nuclear fuel; and a storage pump (P2) for storing the test liquid, which goes through a plurality of simulating members (114) inside the column, to a storage tank (T2) on the top of the column (122).

The plurality of simulating members (114) is composed of a canister simulating member (114A) including copper and iron membranes from the bottom; a buffer simulating member (114B) which is compressed bentonite; a backfill simulating member (114C) which is granular bentonite; a supercontainer simulating member (114D) including titanium-coated membranes; and a host rock simulating member (114E) filled with granite.

In other words, the simulating apparatus of the present invention may utilize isothermal-isohumidity controlling chambers and apply for conditions of inner columns equally for forming environmental conditions equally in the overall geological disposal facilities.

Further, the plurality of simulating members has the same technical constitutions of the multiple barrier systems of the engineered barrier (10) and the natural barrier (20), which are geological disposal facilities as explained above, and thus, detailed explanations are omitted.

Accordingly, the simulating apparatus of the present invention may build up conditions in which actual specifications of geological disposal facilities may be established with safety and high reliability.

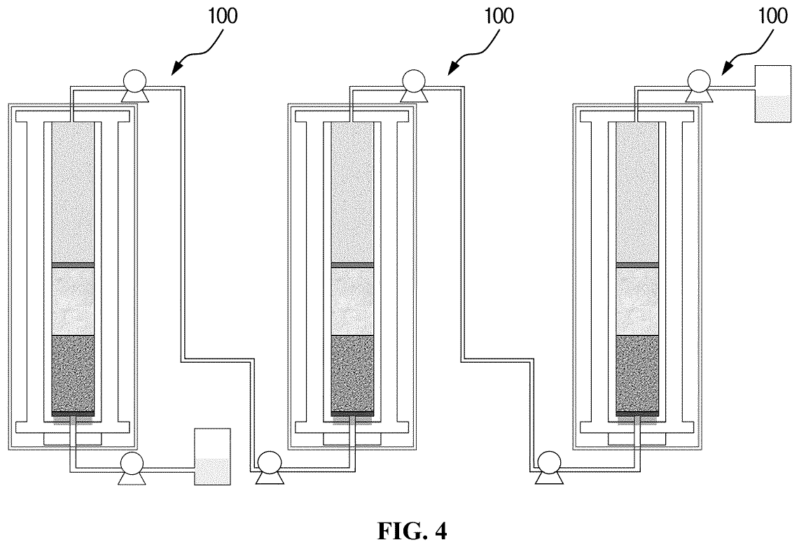

FIG. 4 illustrates a reference drawing for explaining other embodiment according to FIG. 3.

The constitution as illustrated provides a technical constitution which may evaluate influence on canisters through the environment simulating part of a deep geological disposal facility which is in a consecutive constitution.

The simulating apparatus (1) is connected to at least one or more than plurals.

In other words, each storage pump is connected to the supply pump by connecting at least one simulating apparatus, i.e., in a serial form, thereby enabling to suggest technical conditions on gaps of canisters which will be reflected to a basic design of the deep geological disposal facilities.

### EXPLANATIONS OF NUMERAL REFERENCE

| | |
|---|---|
| 1: deep geological disposal facility | |
| 10: engineered barrier | 12: canister |
| 12A: first membrane layer | 14: buffer |
| 16: backfill | 18: supercontainer |
| 18A: second membrane layer | 20: natural barrier |
| 100: simulating apparatus | |
| 110: environment simulating part | 112: deep geological disposal facilities |
| 114: simulating members | 114A: canister simulating member |
| 114B: buffer simulating member | 114C: backfill simulating member |
| 114D: supercontainer simulating member | 114E: host rock simulating member |
| 120: chamber | 122: column |

1. A deep geological disposal facility for spent nuclear fuel comprising a multiple barrier system having an engineered barrier and a natural barrier,
wherein the engineered barrier consists of a canister, a buffer, a backfill and a supercontainer, while the canister comprises a first membrane layer for withstanding corrosion and pressure with spent nuclear fuel; the buffer is made of a material which make nuclide migration delay in case that nuclide is leaked out of the canister; the backfill is made of a material which limits nuclide migration, as engineered barrier; and the supercontainer consists of a second membrane layer for withstanding corrosion and having a low heat conductivity, and
wherein the natural barrier is filled with host rock at a depth of more than 500 meters for delaying nuclide transport when nuclide leaks out and preventing radioactive materials from being leaked out toward environment.

2. The deep geological disposal facility for spent nuclear fuel according to claim 1, wherein the first membrane layer comprises copper and iron materials.

3. The deep geological disposal facility for spent nuclear fuel according to claim 1, wherein the buffer is made of compressed bentonite, and the backfill is made of granular bentonite.

4. The deep geological disposal facility for spent nuclear fuel according to claim 1, wherein the second membrane layer is made of titanium.

5. The deep geological disposal facility for spent nuclear fuel according to claim 1, wherein the host rock is made of granite.

6. A simulating apparatus for deep geological disposal facilities of spent nuclear fuel comprising: an environment simulating part of a geological disposal facility for simulating the geological disposal facility for disposal of spent nuclear fuel; and a chamber, with which the geological disposal facility is equipped, for performing isothermal-isohumidity control in the environment simulating part of the geological disposal facility, wherein the chamber comprises a column in which a plurality of simulating members is consecutively stacked from the bottom; a supply pump for supplying test liquid, mixing underground water and radioactive nuclide liquid inside a storage tank, to the bottom of the column for implementing spent nuclear fuel; and a storage pump for storing the test liquid, which goes through a plurality of simulating members inside the column, to a storage tank on the top of the column.

7. The simulating apparatus for deep geological disposal facilities of spent nuclear fuel according to claim 6, wherein the plurality of simulating members is composed of a canister simulating member including copper and iron membranes from the bottom; a buffer simulating member which is compressed bentonite; a backfill simulating member which is granular bentonite; a supercontainer simulating member including titanium-coated membranes; and a host rock simulating member filled with granite.

8. The simulating apparatus for deep geological disposal facilities of spent nuclear fuel according to claim 6, wherein the simulating apparatus is connected to at least one or more than plurals.
